(19) United States
(12) Patent Application Publication
(10) Pub. No.: US 2003/0211006 A1
(43) Pub. Date: Nov. 13, 2003

(54) Multilayer reagent test strips that include at least one fluid flow control layer and methods for using the same

(76) Inventors: Suyue Qian, Fremont, CA (US); Koon-wah Leong, Sunnyvale, CA (US)

Correspondence Address: BOZICEVIC, FIELD & FRANCIS LLP, 200 MIDDLEFIELD RD, SUITE 200, MENLO PARK, CA, 94025, US

(21) Appl. No.: 10/144,165

(22) Filed: May 10, 2002

(51) Int. Cl. G01N 31/22; G01N 21/27

(52) U.S. Cl. 422/56; 422/57; 422/58; 422/61; 422/68.1; 422/82.05; 436/8; 436/43; 436/44; 436/46; 436/169

(57) ABSTRACT

Multilayer reagent test strips that include at least one hydrophobic fluid flow delay layer, as well as methods for using the same, are provided. The hydrophobic fluid flow delay layer of the subject test strips is one that has been treated with an non-polar organic solvent to provide for a layer which delays fluid flow through a multilayer reagent test strip in a reproducible manner. Also provided are kits and systems that include the subject test strips and find use in practicing the subject methods. The subject compositions and methods find use in a variety of different analyte detection applications.

### INTRODUCTION

1. Field of the Invention

The field of this invention is analyte detection, particularly analyte detection with hand held reagent test strip devices.

2. Background of the Invention

Analyte detection in physiological fluids, e.g., blood or blood derived products, is of ever increasing importance to today's society. Analyte detection assays find use in a variety of applications, including clinical laboratory testing, home testing, etc., where the results of such testing play a prominent role in diagnosis and management in a variety of disease conditions. Analytes of interest include glucose, alcohol, formaldehyde, L-glutamic acid, glycerol, galactose, glycated proteins, creatinine, ketone body, ascorbic acid, lactic acid, leucine, malic acid, pyruvic acid and uric acid, steroids, etc. Analytes of interest also include tumor markers, cardiac markers, hormone level determinants and drug monitoring determinants, etc. In response to this growing importance of analyte detection, a variety of analyte detection protocols and devices for both clinical and home use have been developed.

A wide range of disposable assay devices has been developed for use either in analytical laboratories or in physicians' offices or homes. These devices, because they are used by inexperienced operators, should be simple to operate and should incorporate all the reagents necessary for the test to be conducted.

Many of the disposable assay devices currently in use include one or more reagent zones comprising layers incorporated with assay reagents. Among the problems encountered in use of these devices is the premature interaction or migration of these reagents, either during the manufacturing process or upon introduction of the sample to the device. Both enzymatic and chemical reactions often require incubation steps. One of the challenges in designing a truly “one-step” disposable device is to provide a means to delay the fluid flow from one layer to the next in order to allow for proper incubation periods, i.e., to control fluid flow between different regions. This problem is particularly challenging for non-instrumented disposable analytical devices.

Ideally, a disposable assay device should include a means to delay the flow of the sample through the device for a predetermined time to permit incubation of the sample with the reagents or indicators present in a particular region of the device. After the incubation period, which is generally on the order of a few minutes or less, the sample then flows to the next region of the device for further processing, if desired.

To date, a variety of different fluid control elements have been developed for use in hand-held, simple devices, which include both mechanical and chemical elements. However, there continues to be an interest in the development of additional fluid control elements, particular chemical elements that are simple and inexpensive, and do not adversely affect reagent members present in the assay devices.

Relevant Literature

Patents of interest include U.S. Pat. No. 5,447,689.

### SUMMARY OF THE INVENTION

Multilayer reagent test strips that include at least one hydrophobic fluid flow control layer, as well as methods for using the same, are provided. The hydrophobic fluid flow control layer of the subject test strips is one that has been treated with a non-polar organic solvent to provide for a layer that delays fluid flow through a multilayer reagent test strip in a reproducible manner. Also provided are kits and systems that include the subject test strips and find use in practicing the subject methods. The subject compositions and methods find use in a variety of different analyte detection applications.

### BRIEF DESCRIPTION OF THE FIGURES

FIGS. 1 to 5 provide graphical representations of results obtained from the different coating conditions for color developing membranes in the experimental section of the present application.

### DESCRIPTION OF THE SPECIFIC EMBODIMENTS

Multilayer reagent test strips that include at least one hydrophobic fluid flow control layer, as well as methods for using the same, are provided. The hydrophobic fluid flow control layer of the subject test strips is one that has been treated with a non-polar organic solvent to provide for a layer that delays fluid flow through a multilayer reagent test strip in a reproducible manner. Also provided are kits and systems that include the subject test strips and find use in practicing the subject methods. The subject compositions and methods find use in a variety of different analyte detection applications.

Before the subject invention is described further, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an” and “the” include plural reference unless the context clearly dictates otherwise. Unless defined otherwise, all technical and scientific terms used herein have the same meaning as commonly understood to one of ordinary skill in the art to which this invention belongs.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the preferred methods, devices and materials are now described.

All publications mentioned herein are incorporated herein by reference for the purpose of describing and disclosing the cell lines, vectors, and methodologies, which are described in the publications, which might be used in connection with the presently described invention.

As summarized above, the subject invention provides multilayer reagent test strips for use in analyte detection, as well as systems and kits that include the subject test strips. In further describing the invention, the test strips are described first in greater detail, followed by a review of the methods of using the test strips to detect/quantitate analytes in a fluid sample. Finally, a review of representative systems and kits according to the subject invention is also provided.

Multilayer Reagent Test Strips

As summarized above, the subject invention provides multilayer reagent test strips, where the subject test strips include at least one hydrophobic layer that serves to control, e.g., delay, fluid flow through the layers of the device in a controlled and reproducible manner. By reproducible manner is meant that any variation in fluid flow through two identical devices does not vary by more than about 25 fold, usually by no more than about 15 fold and often by no more than about 10-, about 5- or even about 2-fold. The number of distinct layers that make up the subject test strips may vary, typically ranging from about 2 to 10, usually from about 2 to 8 in many embodiments.

The fluid flow control layer of the subject multilayer reagent test strips is a matrix or membrane structure that has been rendered hydrophobic via treatment with an organic solvent in a manner that provides for the desired reproducible fluid flow control. The matrix material is one that is porous and provides for flow of sample fluid through the material. The matrix that is employed in this layer is typically an inert porous matrix. As such, the matrix is one that is permissive of aqueous fluid flow through it. A number of different porous matrices have been developed for use in various analyte detection assays, which matrices may differ in terms of materials, pore sizes, dimensions and the like, where representative matrices include those described in U.S. Pat. Nos. 55,932,431; 5,874,099; 5,871,767; 5,869,077; 5,866,322; 5,834,001; 5,800,829; 5,800,828; 5,798,113; 5,670,381; 5,663,054; 5,459,080; 5,459,078; 5,441,894 and 5,212,061; the disclosures of which are herein incorporated by reference. The dimensions and porosity of the matrix may vary greatly, where the matrix may or may not have a porosity gradient, e.g., with larger pores near or at the sample application region and smaller pores at the detection region. Examples of specific matrix materials of interest include, but are not limited to, those prepared from polyamide (nylon), polysulfone, nitrocellulose, polyester, polyacrylate, cellulose, and polycarbonate etc.

The above fluid flow control layer matrix is one that is treated to provide for the desired fluid flow control properties. Specifically, the matrix is one that has been treated to delay entry of an aqueous fluid into the matrix in a controlled and reproducible manner, such that an aqueous fluid does not immediately enter the matrix from an upstream layer, but instead is delayed in the upstream layer prior to entering the matrix. The amount of time required for an aqueous fluid to enter a treated layer of the subject strips is at least about 2-fold, often at least about 5-fold and more often at least about 10-fold longer than the entry time that is observed into a corresponding untreated matrix, i.e., control.

Typically, the matrix is treated by rendering it hydrophobic. A feature of the subject invention is that the matrix is rendered hydrophobic by treating the matrix with an organic solvent, e.g., by coating the matrix with an organic solvent, for example by dipping the membrane in an organic solvent. Any convenient organic solvent may be employed, so long as it renders the matrix hydrophobic and does not adversely affect any reagents present in the matrix, if they are present. Organic solvents of interest are generally non-polar organic solvents, and include, but are not limited to: chloroform, dichloromethane, halogenated hydrocarbon, hydrocarbon, ethyl acetate, and the like.

The matrix may be treated with the solvent using any convenient protocol, e.g., by applying the solvent to the matrix, by immersing the matrix in the solvent, etc., where the particular protocol employed is selected primarily in terms of convenience. As such, the fluid flow control layers of the subject invention are matrix or membrane structures that include organic solvent molecules, where the molecules are present in a manner that imparts to the layer the desired fluid flow control characteristics.

In certain embodiments, the fluid flow control layers as described above include one or more reagents that are employed in the assay that is to be performed in the device, where representative types of reagents include: analyte preparation reagents, such as enzymes, etc.; signal producing system reagents, such as enzymes, indicator compounds, mediators, etc.; interfering agent inhibitor reagents; and the like. Representative reagents that may be present in the fluid flow control layer, as well as protocols for the preparation thereof, include those described in U.S. Pat. Nos. 6,335,203; 6,268,162; 6,218,571; 6,200,773; 5,972,294; 5,922,530; and 5,753,452 the disclosures of which are herein incorporated by reference.

In addition to the above-described fluid flow control layer, the subject multilayer test strips further include at least one additional layer that is distinct from the fluid flow control layer. Additional distinct layers that may be present include, but are not limited to: sample preparation layers, e.g., blood separation layers; analyte preparation layers, e.g., analyte precursor processing layers; signal producing system layers; etc.

The subject fluid flow control layers can be incorporated into a variety of different multilayer reagent strips. In other words, the subject fluid flow control layers may be employed in any multilayer strip configuration in which it is desired to control fluid flow from one layer to another in a reproducible manner.

One particular multilayer test strip configuration in which the subject fluid flow control layers find use is the glycated protein quantitation multilayer reagent test strip device described in U.S. patent application Ser. No. 10/______ filed on even date herewith entitled “Multilayer Reagent Test Strips and Methods for Using the Same to Quantify Glycated Protein in a Physiological Sample,” (having an attorney docket number of LIFE-088/LFS-235) the disclosure of which is herein incorporated by reference.

The subject reagent test strips may be fabricated employing any convenient protocol. Typically, the various layers are fabricated separately, e.g., by using conventional dipping protocols in one or more reagent solutions, and then assembled into a final test strip. A representative fabrication protocol is provided in the experimental section, infra.

Methods of Analyte Detection

The above described reagent test strips find use in methods of detecting the presence of, and often the amount of, an analyte in a sample. A variety of different analytes may be detected using the subject methods, where representative analytes include but are not limited to: glycated proteins, uric acid, fructosamine, steroids, etc. The hydrophobic rendering of the membrane controls sample flow from the first step of the test to the second step of the test. In anyny test that involves two or more sequential steps, this invention can be used to simplify the test. It can convert an automated laboratory test or multiple step striptest into one single step home test. For example, in most enzyme immunoassays, antibody to antigen or hapten binding is the first step; color formation is the second step. The enzyme immunoassay is widely used in the clinical laboratory for cardiac marker detection, therapeutic drug monitoring, and tumor marker or hormone level determination. Cardiac markers have myoglobin, troponin, tropmyosin etc. Drug monitoring includes theophylline, digoxin, phenoborbital, opiates, barbiturates and amphetamines etc. Tumor markers have ACTH, HCG, neurophysins, calcitonin, carcinoembryonic antigen, prostaglandin antigen etc. Hormones include HCG, ACTH, growth hormone, prolactin, insulin-like growth factors etc. HbA1c test also involves more than two steps. HbA1c denaturing is the first step and antibody antigen (HbA1c) binding is the second step, and color formation is the third step.

While in principle, the subject methods may be used to determine the presence, and often concentration, of an analyte in a variety of different physiological samples, such as urine, tears, saliva, and the like, they are particularly suited for use in determining the concentration of an analyte in blood or blood fractions, e.g., blood derived samples, and more particularly, in whole blood.

In practicing the subject methods, the first step is to apply a quantity of the physiological sample to the test strip, where the test strip is described supra. The amount of physiological sample, e.g., blood, that is applied to the test strip may vary, but generally ranges from about 2 μL to 40 μL, usually from about 5 μL to 20 μL. Because of the nature of the subject test strip, the blood sample size that is applied to the test strip may be relatively small, ranging in size from about 2 μL to 40 μL, usually from about 5 μL to 20 μL. Where blood is the physiological sample, blood samples of a variety of different hematocrits may be assayed with the subject methods, where the hematocrit may range from about 20% to 65%, usually from about 25% to 60%.

Following application of the sample to the test strip, the sample is allowed to react with the members of the signal producing system to produce a detectable product that is present in an amount proportional to the initial amount of the analyte of interest present in the sample. The amount of detectable product, i.e., the signal produced by the signal producing system, is then determined and related to the amount of analyte in the initial sample.

Analyte Detection Systems

Analyte detection systems useful for practicing the subject methods include a reagent test strip and a detection instrument, e.g., an automated detection instrument. In such systems, a physiological sample is applied to the test strip as described above and the signal produced by the signal producing system is detected and related to the presence (and often the amount) of analyte in the sample by the automated instrument. The above described reaction, detection and relation steps, and instruments for practicing the same, are further described in U.S. Pat. Nos. 4,734,360; 4,900,666; 4,935,346; 5,059,394; 5,304,468; 5,306,623; 5,418,142; 5,426,032; 5,515,170; 5,526,120; 5,563,042; 5,620,863; 5,753,429; 5,573,452; 5,780,304; 5,789,255; 5,843,691; 5,846,486; 5,902,731; 5,968,836 and 5,972,294; the disclosures of which are herein incorporated by reference. In the relation step, the derived analyte concentration takes into account the constant contribution of competing reactions to the observed signal, e.g., by calibrating the instrument accordingly.

The subject analyte detection systems include enzyme immunoassay systems for analyte determination, where such systems include multiple test strips forming a strip plate that includes a positively charged porous matrix and a urea derivative dye on at least one surface of the matrix, e.g., an enzyme-linked immunosorbent assay (ELISA) where the enzyme is a peroxidase and the strip plate further includes an analyte-specific antibody on at least one surface of the matrix.

Kits

Also provided by the subject invention are kits for use in practicing the subject methods. The kits of the subject invention include a reagent test strip that includes a peroxide producing signal producing system, as described above, and at least one of a means for obtaining said physiological sample, e.g., a lance for sticking a finger, a lance actuation means, and the like, and an analyte standard, e.g., an analyte control solution that contains a standardized concentration of analyte. In certain embodiments, the kits also include an automated instrument, as described above, for detecting the amount of product produced on the strip following sample application and relating the detected product to the presence (and often the amount) of analyte in the sample. Finally, the kits include instructions for using the subject kit components in the determination of an analyte concentration in a physiological sample. These instructions may be present on one or more of the packaging, a label insert, containers present in the kits, and the like.

The following examples are offered by way of illustration and not by way of limitation.

### EXAMPLES

### Example 1

Color development and fluid flow control layer: Six different conditions of nylon membrane treatment were studied to determine which one gave the best performance. Nylon membrane from Pall was coated with A. B. C dips in sequence as listed in table below. Each coating was done by simply dipping membrane through the solution, and after removing excess solution, the membrane was dried in the 56° C. oven for 5 minutes. The membrane coating with C₂₂ fatty acid or chloroform was dried under ventilation hood at room temperature for 1-2 minutes

| Membrane | A dip | B dip | C dip |
|---|---|---|---|
| Treatment | (first dip) | (second dip) | (third dip) |
| 1 | C₂₂ fatty acid | KAO/HRP | DA-67 |
| 2 | KAO/HRP | DA-67 | C₂₂ fatty acid |
| 3 | Chloroform | KAO/HRP | DA-67 |
| 4 | KAO/HRP | DA-67 | Chloroform |
| 5 | KAO/HRP | DA-67 | |
| 6 | KAO/HRP | DA-67 | |

C₂₂ fatty acid coating solution is 1% C₂₂ fatty acid dissolved in chloroform.

1 mM of DA-67 (10-(carboxymethylaminocarbonyl)-3,7-bis(dimethylamino)phenothiazine) was dissolved in 20% methanol.

KAO/HRP coating solution is 300 U/ml KAO, 1 mg/ml HRP, 1% PVP (36K) and 50 mg/ml mannitol in 0.1 M EPPS or 20 mM PBS.

Digestion layer: ½ inch width porex was coated with 100 mg/ml of protease XIV in 0.1 M EPPS, pH 8.0 buffer. After removing excess coating solution, the porex was dried in the oven at 56° C. for 10 minutes.

Strip assembly: The color development membrane was cut into ¼ inch width strip and pasted on a polyester support strip. Porex was stacked on top of the membrane. The strip was constructed according to U.S. Pat. No. 6,335,203.

Serum sample was applied onto the six different strips and time of sample completely absorbed on nylon membrane was observed visually. Color uniformity was also graded.

The following table summarizes the results of the 6 strips with different coating condition on color development membranes.

| Membrane | Delay Absorption | | |
|---|---|---|---|
| Treatment | Time (min) | Color Uniformity | Color Intensity |
| 1 | 15 | +++++ | +++++ |
| 2 | 20 | ++++ | +++++ |
| 3 | 2 | ++++ | +++++ |
| 4 | 20 | +++++ | +++++ |
| 5 | 2 | ++ | ++++ |
| 6 | 1 | + | ++ |

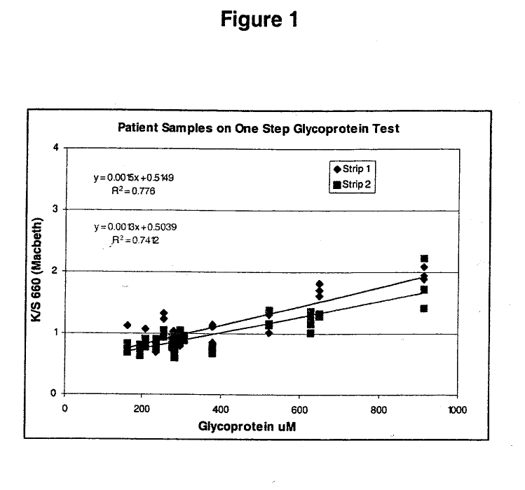

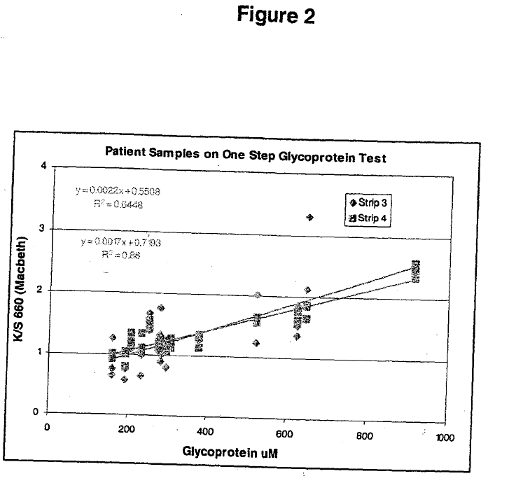

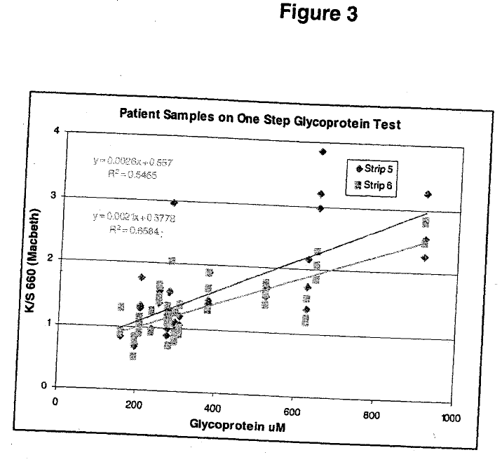

35 μl of serum sample was applied on porex side of strip. The strip was incubated at 37° C. for 20 min. Immediately after incubation, the strip was read on Macbeth at 660 nm wavelength. Triplicates measurements of 15 samples in 6 different conditions were summarized in FIGS. 1, 2 and 3. Glycoprotein values were obtained by Genzyme GlyPro assay run on Cobas Fara II for reference. Intercept indicates the background of the strip after sample was applied; lower background is preferred. Slope indicates the resolution power of glycoprotein concentration in clinical range; steeper slope is preferred. Comparing the correlation value R² among different conditions, strip 4 has the best performance.

*Serum samples were obtained from Aalto Scientific Ltd.

### Example 2

Chloroform vs Dichloromethane

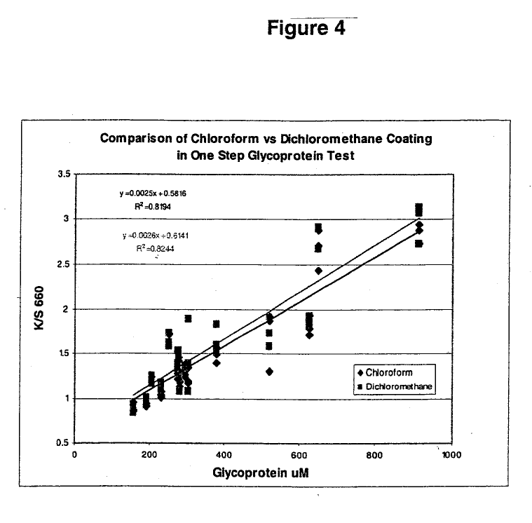

Since chloroform is a carcinogen. Dichloromethane was tried to replace the chloroform. The strip was made as described in example 1. All the test procedure is same as example 1. Summarized data show in FIG. 4. Data shows that chloroform and dichlormethane give similar results. Hydrophobic treatment on nylon membrane does delay the fluid flow and provides considerable time delay for protein digestion to complete in the layer above the color formation layer in a glycated protein assay.

### Example 3

One Step vs Two Step

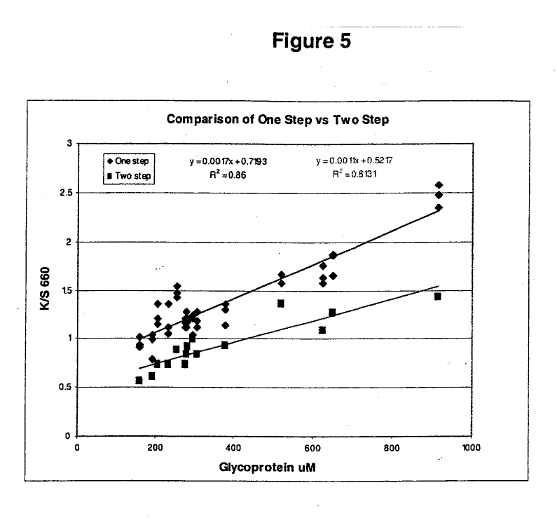

The purpose of the hydrophobic coating on nylon membrane is to put two step test into one. Example 3 is comparing one step to two step. One step was done per example 2. Two step test was done as: serum sample was first applied on a separate digestion strip which was coated with protease XIV. After 20 minutes incubation at 37° C., digested sample was transferred to a color formation strip coated with KAO/HRP and DA-67. All the coating conditions in the two step strip were identical to one step strip format except without dichloromethane coating on color development membrane. FIG. 5 shows that one step test format is comparable or better than two step test. Although the two step format gives lower background signal, the one step format gives higher sensitivity better correlation than the two step format. Moreover, the one step format test is very easy to perform.

It is evident from the above results and discussion that the subject invention provides a simple and effective way to provide for precise fluid flow control in a multilayer reagent test strip. As such, the subject invention represents a significant contribution to the art.

All publications and patents cited in this specification are herein incorporated by reference as if each individual publication or patent were specifically and individually indicated to be incorporated by reference. The citation of any publication is for its disclosure prior to the filing date and should not be construed as an admission that the present invention is not entitled to antedate such publication by virtue of prior invention.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

What is claimed is:

1. A method of making a multilayer test strip, said method comprising:
(a) providing a matrix layer;
(b) rendering said matrix layer hydrophobic by treating said layer with an organic solvent to produce a fluid flow control layer; and
(c) preparing a multilayer test strip using said fluid flow control layer.

2. The method according to claim 1, wherein said organic solvent is non-polar.

3. The method according to claim 1, wherein said rendering step comprises immersing said matrix layer in a volume of said organic solvent.

4. The method according to claim 1, wherein said matrix material further comprises at least one reagent.

5. The method according to claim 4, wherein said reagent is a member of a signal producing system.

6. The method according to claim 1, where said preparing step comprises placing said fluid control layer in fluid communication with at least one additional layer of a multilayer test strip.

7. A multilayer reagent test strip comprising a fluid flow control layer produced according to claim 1.

8. The reagent test strip according to claim 7, wherein said fluid flow control layer includes at least one reagent.

9. The reagent test strip according to claim 8, wherein said reagent is a member of a signal producing system.

10. A measurement system for measuring an amount of analyte in a fluid sample, said system comprising:
(a) a multilayer test strip according to claim 7; and
(b) a signal detection instrument for detecting signal produced on said multilayer test strip.

11. A method for detecting the presence of an analyte in a physiological sample, said method comprising:
(a) applying said physiological sample to a multilayer test strip according to claim 7;
(b) detecting a signal produced on said test strip to detect said analyte in said physiological sample.

12. The method according to claim 11, wherein said physiological sample is whole blood.

13. The method according to claim 11, wherein said method is a method of quantitating said analyte in said sample.

14. The method according to claim 11, wherein said detecting step is performed by an automated instrument.

15. A kit for use in determining the concentration of an analyte in a physiological sample, said kit comprising:
(a) a multilayer reagent test strip according to claim 7; and
(b) at least one of:
(i) a means for obtaining a physiological sample and
(ii) a control.

16. The kit according to claim 15, wherein said means for obtaining said physiological sample is a lance.

17. The kit according to claim 15, wherein said control comprises a standardized concentration of said analyte.

18. The kit according to claim 15, wherein said kit comprises both said means for obtaining said physiological sample and control.

19. A signal detection instrument having present therein a multilayer reagent test strip according to claim 7.

20. The instrument according to claim 19, wherein said instrument is an automated instrument.
